(19) United States
(12) Patent Application Publication
(10) Pub. No.: US 2025/0078079 A1
(43) Pub. Date: Mar. 6, 2025

(54) Distributed, Privacy Preserving, Payments Fraud Detection System

(71) Applicant: Bank of America Corporation, Charlotte, NC (US)

(72) Inventors: Prahaladh Chandrahasan, Pallikaranai (IN); Sujatha Balaji, Kovilambakkam (IN)

(73) Assignee: Bank of America Corporation, Charlotte, NC (US)

(21) Appl. No.: 18/239,214

(22) Filed: Aug. 29, 2023

(51) Int. Cl. G06Q 20/40

(52) U.S. Cl. CPC G06Q 20/4016

(57) ABSTRACT

Various aspects of the disclosure relate to fraud detection for real-time electronic transactions occurring in a plurality of payments systems. At onboarding of a regional or local payments computing system into a distributed privacy preservice payments fraud detection system, a client computing system trains a centralized model of a specific fraud detection architecture on its local dataset. Changes (e.g., gradient matrices) to the model are identified and communicated and communicates its gradients (matrices) to a centralized server. Upon receipt of gradients from one or more client computing systems, the centralized server aggregates the client gradients (periodically, continually, and the like) and sends the updated model to each client computing systems for use in the next federated round.

### BACKGROUND

Large organizations, such as financial institutions and other large enterprise organizations, may provide many different products and/or services, such as electronic transactions and payments services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization so as to provide and/or support different products and services offered by the organization.

As a result of the complexity associated with the operations of a large organization and its computer systems, it may be difficult for such an organization, such as a financial institution, to manage its computer systems efficiently, effectively, securely, and uniformly, and particularly to manage protection of computer systems from instances of fraud and/or other malicious activity that may occur with a payments computing system.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes fraud detection for real-time transactions via a distributed federated learning-based platform including privacy protection measures while sharing identified fraudulent activity patterns between regional computing systems.

Aspects of the disclosure relate to computer hardware and software. In particular, one or more aspects of the disclosure generally relate to computer hardware and software for providing a federated learning paradigm-based computing system distributed over a plurality of independent computing systems to enable a privacy-preserving fraud detection system.

At onboarding of a regional or local payments computing system into the distributed privacy preservice payments fraud detection system, a client computing system trains a centralized model of a specific fraud detection architecture on its local dataset. Changes (e.g., gradient matrices) to the model are identified and communicated and communicates its gradients (matrices) to a centralized server. Upon receipt of gradients from one or more client computing systems, the centralized server aggregates the client gradients (periodically, continually, and the like) and sends the updated model to each client computing systems for use in the next federated round.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for decentralized, privacy preserving, payments fraud detection, in accordance with one or more aspects described herein;

FIG. 1B shows an illustrative computing platform enabled for decentralized, privacy preserving, payments fraud detection, in accordance with one or more aspects described herein;

FIG. 2 shows an illustrative process for decentralized, privacy preserving, payments fraud detection, in accordance with one or more example arrangements; and

FIG. 3 shows an illustrative system for decentralized, privacy preserving, payments fraud detection in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

Due to increasing use of electronic payments systems, countries are increasingly shifting regulations to utilize and encourage use of real time payments standards such as Immediate Payment System (IMPS), Interbank Electronic Payment System (SPEI), Real-Time Retail Payments Platform (RPP), and internationally recognized standards such as International Standards Organization (ISO) 20022 and 8583, and/or the like. As a result, fraud detection techniques must be robust and real-time to prevent fraudulent transactions within a real-time payments computing system. Because the percentage of electronic fraudulent transactions in any financial computing system is incomparable to the total volume of electronic fraud-less transactions, building a dataset for a deep learning model for use with any individual payments computing system is an uphill battle. While Additionally, privacy concerns are a major impediment in current computerized methods attempted for developing a fraud detection system based on supervised learning inter-bank collaboration due to a need to avoid sharing sensitive transactional data. Further technical issues involved with implementing payments fraud detection system using intra-bank collaboration across different regions due to differing data protection compliance standards that must all separately be coded, and implemented within a trained model. For example, the European Union follows General Data Protection Regulation (GDPR) and the US follows the Payment Card Industry Data Security Standard (PCI DSS). Further, if a specific fraud pattern has been detected within a specific geographic or organizational computing system, the ability for another computing system to detect that same fraud pattern is difficult, if not nearly impossible, without data sharing between the organizational computing systems. While fast payments may provide several benefits, the completion of these real-time transactions also generate vulnerabilities. Additionally, the rapidly increasing volume of real-time transactions, with a small percentage of fraudulent transactions with respect to the total overall volume also makes identification of fraudulent transactions, and exception management in general, more difficult. Real-time payment transactions have a shortened payment processing time and, as such, have a decreased ability to conduct fraud and/or malicious activity analysis. For example, real-time payment transactions only provide minimal (e.g., 1 second, 2 second, 5 seconds, or the like) for fraud detection systems to analyze each payment transaction. As such, a need has been recognized for efficiently detecting small numbers of fraudulent payments transactions in real-time.

While real-time payments systems offer many advantages, risks are present as well. For example, real-time payments transactions complete quickly, but result in minimal opportunities for fraud detection systems to identify problematic transactions. Additionally, many real-time payments systems allow for use of aliases that allow for ease of use and improves convenience, the aliases and/or proxy identifiers also present security concerns. Fraud detection methodologies may differ across jurisdictions based on locally and/or nationally implemented regulations. As such, a need has been recognized to identify patterns that may be indicative of fraud across multiple jurisdictions and share the patterns without sharing secure and/or private information

Presently, multiple messaging protocol standards exist and are adopted throughout the world. For example, many countries and/or regions (e.g., the United States, Australia, China, Europe, and the like) have adopted the ISO 20022 messaging standard, as it is flexible and extensible and therefore enables richer and more complete remittance information (280 characters) to be sent with a payment than other systems (for instance, the 18 characters currently available for direct-entry payments). Additionally, ISO 20022 provides a rich data format that may allow use of extended character sets that facilitate integration with national language libraries, such as for Chinese characters. Other countries have adopted proprietary messaging standards. For example, India has adopted other messaging standards (e.g., ISO 8583) that was implemented in an XLM-based proprietary messaging standard, for increased flexibility. For example, native XML protocol provided flexibility to have message-level acknowledgement and an ability to provide innovative services such as check transaction status and validation of payment address in a short period. Mexico has also adopted a propriety messaging standard to facilitate efficient communication of information while including security checks that validate the authenticity of the participant that generates instructions. Because of the investment in deploying the customized standards and the perceived advantages for the local authority, the proprietary standards will likely persist for years or decades. Although use of a single standard, such as ISO 20022, may allow multinational organizations (e.g. financial institutions, corporations, and the like) to utilize a single message standard across multiple payment-related computing systems.

In an illustrative case, a fraud detection system may be trained similarly to a federated learning paradigm over multiple computing systems representing various enterprise organizations (e.g., financial institutions, vendor payment systems, and the like) across various regions and/or legal jurisdictions. A federated learning-based system is based on a learning paradigm solves problems via a loose federation of participating devices (client computing devices) that are coordinated by a central server. Data stored in the client is not uploaded to the central server, instead each client updates the global model maintained by the central server via gradient updates identified on each local computing device that are shared to the central server. The central server then aggregates the updates from the client computing devices or systems, updates the central model and sends the updated models back to clients. The models may be neural network models, artificial intelligence/machine learning (AI/ML) models, deep learning models, and/or the like.

Input for a fraud detection model used in the distributed, privacy preserving, payments fraud detection system includes fields defined for use in one or more standardized real-time payments computing systems. In some cases, different payment standards for real-time payments may be defined for different regions. In some cases, the inputs from the various payments systems may be identified from various payment initiation schemes like payments initiation (PAIN)113 or MT101 which act as an input to the fraud detection system. In some cases, the inputs may be normalized and/or mapped onto a standardized input set of the centralized model. Only after a no-fraud confirmation from the fraud detection system would the file be further processed.

Due to regulatory and legal requirements, different real-time payments systems have been implemented across the globe. These installations have been increasing, with differences noted between different countries, based on goals identified for their national interests. For example, Australia implemented a New Payments Platform (NPP) to receive low-value payments outside normal banking hours, to send more complete remittance information with payments, and to address payments in a simple manner. In India, the Immediate Payment System (IMPS) and the Unified Payments Interface (UPI) facilitate financial inclusion and promoting digital payments, where IMPS is a multichannel system that can be accessed using mobile, ATM, internet banking, bank branches, with UPI as an interoperable real-time 24/7 mobile-payment system. In the United States, the Clearing House (TCH) launched a Future Payments Initiative to develop a strategic view of real-time payments targeting payment needs in an increasingly digital economy to facilitate a fast payment arrangement to maintain and improve the safety and soundness of existing payment systems. Additional countries (e.g., Bahrain, Malaysia, Mexico, the United Kingdom, China, and others) and regional authorities (e.g., the European Union) have also performed studies and/or have implemented standards to facilitate robust real-time payments systems that may be interoperable with existing and emerging computing methods.

In many cases, jurisdictions have collaborations with industry bodies, such as banking associations to createg a collaborative ecosystem for fast (e.g., real-time) payments computing systems. Such relationships ensure the effective implementation of guidelines/regulations, including those governing pricing schemes, risk management, and dispute resolution to provide guidelines, rules, and regulations that may be modeled to ensure the safety and resiliency of the payment systems. Payments for one or more of these payment systems may include electronic wallet payment transactions, electronic bill payments, recurring electronic payments such as electronic loan payments, electronic credit card payments, and the like, future electronic payments, bulk payments, person to person (P2P) payments, batch payments, merchant payments, vendor payments, and the like.

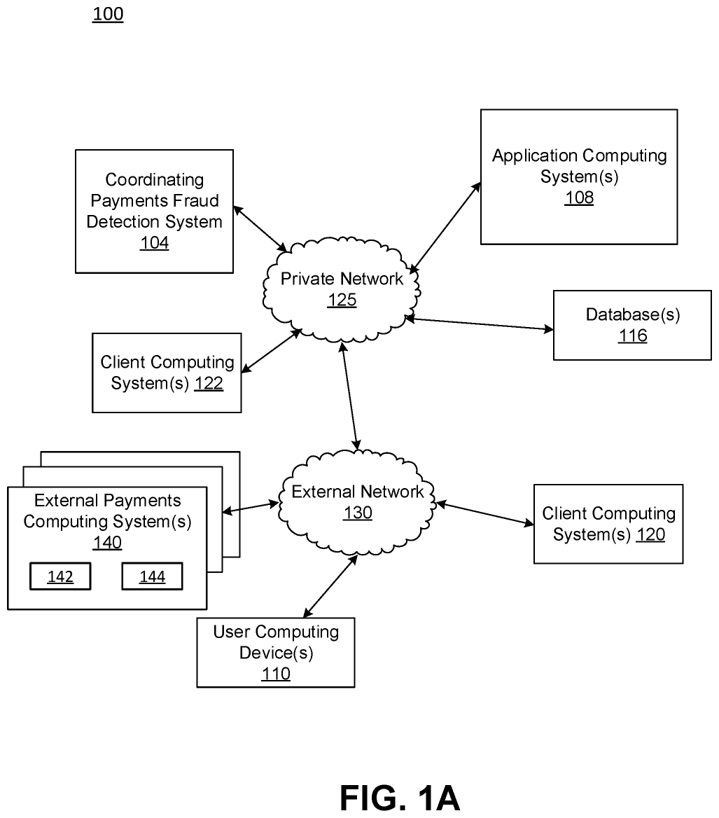

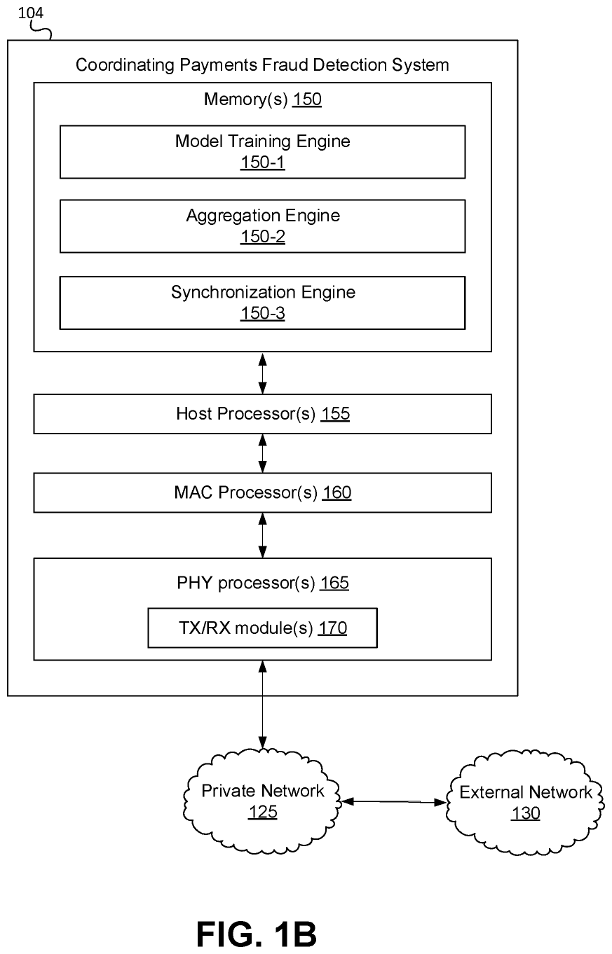

FIG. 1A shows an illustrative computing environment 100 for decentralized, privacy preserving, payments fraud detection, in accordance with one or more aspects described herein. The computing environment 100 may comprise one or more devices (e.g., computer systems, communication devices, and the like). The computing environment 100 may comprise, for example, a coordinating payments fraud detection system 104, one or more application system 108, one or more database(s) 116 and/or one or more client computing systems 122. The one or more of the devices and/or systems, may be linked over a private network 125 associated with an enterprise organization (e.g., a financial institution, a business organization, an educational institution, a governmental organization and the like). The computing environment 100 may additionally comprise a client computing system 120 and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3rd Generation Partnership Project (3GPP) cellular protocol, a hypertext transfer protocol (HTTP), etc.). While FIG. 1A shows the coordinating payments fraud detection system 104 as an independent computing system, the coordinating payments fraud detection system 104 may be implemented as a portion of another computing system.

The coordinating payments fraud detection system 104 may comprise one or more computing devices and/or other computer components (e.g., processors, memories, communication interfaces) configured to perform one or more functions as described herein. Further details associated with the architecture of the coordinating payments fraud detection system 104 are described with reference to FIG. 1B.

The application computing systems 108 and/or the client computing systems 122 may comprise one or more computing devices and/or other computer components (e.g., processors, memories, communication interfaces). In addition, application computing systems 108 and/or the client computing systems 122 may be configured to host, execute, and/or otherwise provide one or more enterprise applications. In some cases, the application computing systems 108 may host one or more services configured facilitate operations requested through one or more API calls, such as data retrieval and/or initiating processing of specified functionality. In some cases, the client computing systems 122 may be configured to communicate with one or more of the application computing systems 108 such as via direct communications and/or API function calls and the services. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The application computing systems 108 and/or the client computing systems 122 may comprise various servers and/or databases that store and/or otherwise maintain account information, such as financial account information including account balances, transaction history, account owner information, and/or other information. In addition, the application computing systems 108 and/or the client computing systems 122 may process and/or otherwise execute transactions on specific accounts based on commands and/or other information received from other computer systems comprising the computing environment 100. In some cases, one or more of the application computing systems 108 and/or the client computing systems 122 may be configured, for example, to host, execute, and/or otherwise provide one or more transaction processing programs, such as electronic fund transfer applications, online loan processing applications, and/or other programs associated with the financial institution.

The application computing systems 108 may be one or more host devices (e.g., a workstation, a server, and the like) or mobile computing devices (e.g., smartphone, tablet). In addition, an application computing systems 108 may be linked to and/or operated by a specific enterprise user (who may, for example, be an employee or other affiliate of the enterprise organization) who may have administrative privileges to perform various operations within the private network 125. In some cases, the application computing system 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing system 120 may comprise one or more computing devices and/or other computer components (e.g., processors, memories, communication interfaces). The client computing system 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing system 120 is for processing an electronic exchange of goods and/or services. The client computing system 120 may be associated with a specific goods purchasing activity, such as purchasing a vehicle, transferring title of real estate may perform communicate with one or more other platforms within the client computing system 120. In some cases, the client computing system 120 may integrate API calls to request data, initiate functionality, or otherwise communicate with the one or more application systems 108, such as via the services 109. For example, the services may be configured to facilitate data communications (e.g., data gathering functions, data writing functions, and the like) between the client computing system 120 and the one or more application computing systems 108.

The user device(s) 110 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125.

The database(s) 116 may comprise one or more computer-readable memories storing information that may be used by the coordinating payments fraud detection system 104. For example, the database(s) 116 may store fraud detection models, fraud detection gradients received from one or more external payments computing systems 140, and the like. In an arrangement, the database(s) 116 may be used for other purposes as described herein. In some cases, the client computing system 120 may write data or read data to the database(s) 116 via the services.

The external payments computing systems 140 may include one or more remote payments computing systems, each incorporating a decentralized privacy preserving fraud detection system 142 processing a trained payments fraud detection model stored in a data store 144. The decentralized privacy preserving fraud detection system 142 may receive a trained model from the coordinating payments fraud detection system 104 and store the model in the data store 144. The decentralized privacy preserving fraud detection system 142 may process the model over time and periodically determine gradients associated with different fields and/or characteristics of the model, where the gradients may be stored in the data store 144 and communicated back to the coordinating payments fraud detection system 104. Once received the coordinating payments fraud detection system 104 may aggregate the gradients from each of the external payments computing systems 140 and retrain or otherwise adjust the model based on the aggregated information. Once updated, the model may be stored in the database 116, along with the individual and/or aggregated gradients. The coordinating payments fraud detection system 104 may then communicate the updated model and/or other information to each of the external payments computing systems 140 for storage in the data store 144 and updating the model processed by the decentralized privacy preserving fraud detection system 142.

In one or more arrangements, the coordinating payments fraud detection system 104, the application computing systems 108, the client computing system 122, the client computing system 120, the user devices 110, the decentralized privacy preserving fraud detection system 142, the data stores 116 and 144, and/or the other devices/systems in the computing environment 100 may be any type of computing device capable of receiving input via a user interface, and communicating the received input to one or more other computing devices in the computing environment 100. For example, the coordinating payments fraud detection system 104, the application computing systems 108, the client computing system 122, the client computing system 120, the user devices 110, the decentralized privacy preserving fraud detection system 142, the data stores 116 and 144, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the coordinating payments fraud detection system 104, the application computing systems 108, the client computing system 122, the client computing system 120, the user devices 110, the decentralized privacy preserving fraud detection system 142, the data stores 116 and 144, and/or the other devices/systems in the computing environment 100 may, in some instances, be and/or comprise special-purpose computing devices configured to perform specific functions.

FIG. 1B shows an illustrative coordinating payments fraud detection system 104 in accordance with one or more examples described herein. The coordinating payments fraud detection system 104 may be a stand-alone device and/or may at least be partial integrated within another computing system may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The coordinating payments fraud detection system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the coordinating payments fraud detection system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 125. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the coordinating payments fraud detection system 104 may be configured to execute machine readable instructions stored in memory 150. The memory 150 may comprise (i) one or more program modules/engines having instructions that when executed by the one or more processors cause the coordinating payments fraud detection system 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the coordinating payments fraud detection system 104 and/or by different computing devices that may form and/or otherwise make up the coordinating payments fraud detection system 104. For example, the memory 150 may have, store, and/or comprise a model training engine 150-1, an aggregation engine 150-2, and a synchronization engine 150-3 and/or the like. The model training engine 150-1 may have instructions that direct and/or cause the coordinating payments fraud detection system 104 to perform one or more operations associated with training a deep learning model for detecting fraudulent transactions in a payments computing system, and the like. The aggregation engine 150-2 may have instructions that may cause the coordinating payments fraud detection system 104 to aggregate model gradients identified by each decentralized privacy preserving fraud detection system 142 from each external payments computing system 140 and updating and/or coordinating retraining of the fraud detection model based on the aggregated gradients. The synchronization engine 150-3 may have instructions that direct and/or cause the coordinating payments fraud detection system 104 to perform one or more operations associated with synchronizing updated model to each decentralized privacy preserving fraud detection system 142 of corresponding external payments computing systems 140.

While FIG. 1A illustrates the coordinating payments fraud detection system 104 and/or the application computing systems 108, as being separate elements connected in the private network 125, in one or more other arrangements, functions of one or more of the above may be integrated in a single device/network of devices. For example, elements in the coordinating payments fraud detection system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the application computing systems 108.

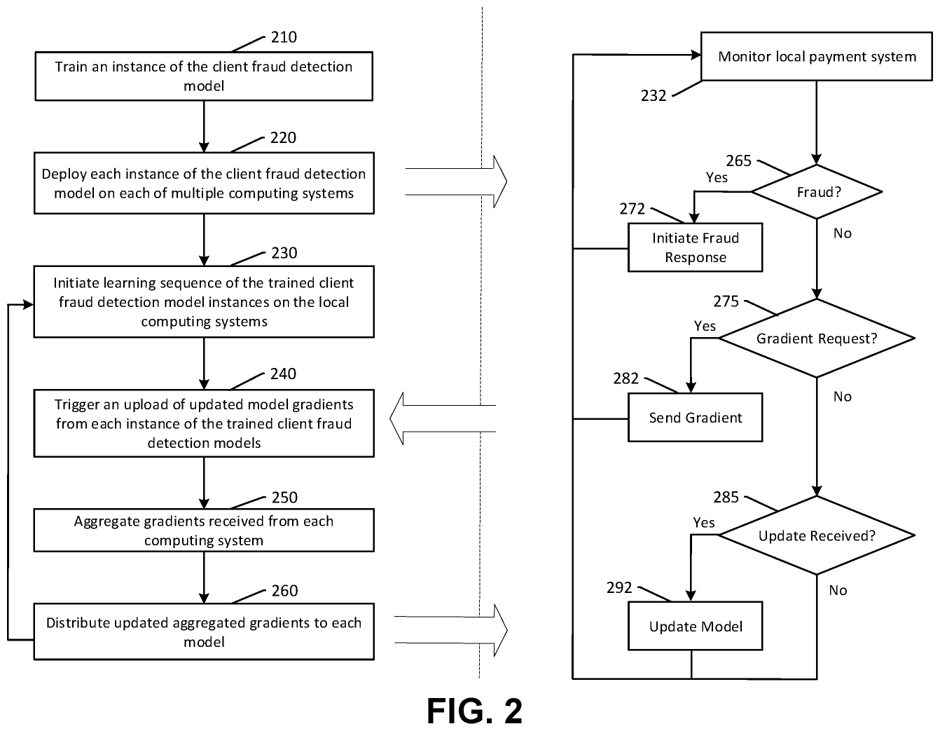

FIG. 2 shows an illustrative process for decentralized, privacy preserving, payments fraud detection, in accordance with one or more example arrangements. At 210, the coordinating payments fraud detection system 104 may train a model to identify fraudulent electronic payment transaction from a large volume of electronic payment transactions processed by a payments computing system for an enterprise organization, for example. At 220, instances of the trained model may be communicated from the coordinating payments fraud detection system 104 to each decentralized privacy preserving fraud detection system 142 associated with a corresponding external payments computing systems 140. At 230, the coordinating payments fraud detection system 104 may initiate activation of the model and processing of each of a volume of payments transactions on the external payments computing systems 140 by the corresponding decentralized privacy preserving fraud detection system 142. During operation, each decentralized privacy preserving fraud detection system 142 may identify gradients of differences associated with the local system processing by the model and may upload the gradients to the coordinating payments fraud detection system 104 at 240, for example, in response to a triggering condition. At 250, the coordinating payments fraud detection system 104 may aggregate each gradient received from each decentralized privacy preserving fraud detection system 142 and update the model. At 260, the updated model may be communicated to each decentralized privacy preserving fraud detection system 142 and activated to monitor the payments transactions in real-time. This completes one federated round or one training cycle.

At 232, one or more one or more decentralized privacy preserving fraud detection system 142 may begin monitoring of payments transactions of an associated payments computing system 140. At 265, one or more decentralized privacy preserving fraud detection system 142 may identify a possible instance of fraudulent activity and if so, may initiate a fraud response at 272 and monitoring continues at 232. If not, the monitoring continues. If, at 275, one or more of the decentralized privacy preserving fraud detection system 142 identifies that a gradient should be uploaded to the coordinating payments fraud detection system 104 (e.g., via a request received from the coordinating payments fraud detection system 104, via expiration of a periodic duration of time, and the like), each of the one or more of the decentralized privacy preserving fraud detection systems 142 may send or otherwise communicate the model gradient to the coordinating payments fraud detection system 104. If, at 285, an update is received from the coordinating payments fraud detection system 104 at the one or more one or more decentralized privacy preserving fraud detection systems 142, the one or more one or more decentralized privacy preserving fraud detection system 142 updates the model at 292 based on the update received and monitoring continues at 232. If no update has been received, the one or more one or more decentralized privacy preserving fraud detection systems 142 continues to monitor the real-time payment transactions occurring on the one or more one or more decentralized privacy preserving fraud detection systems 142.

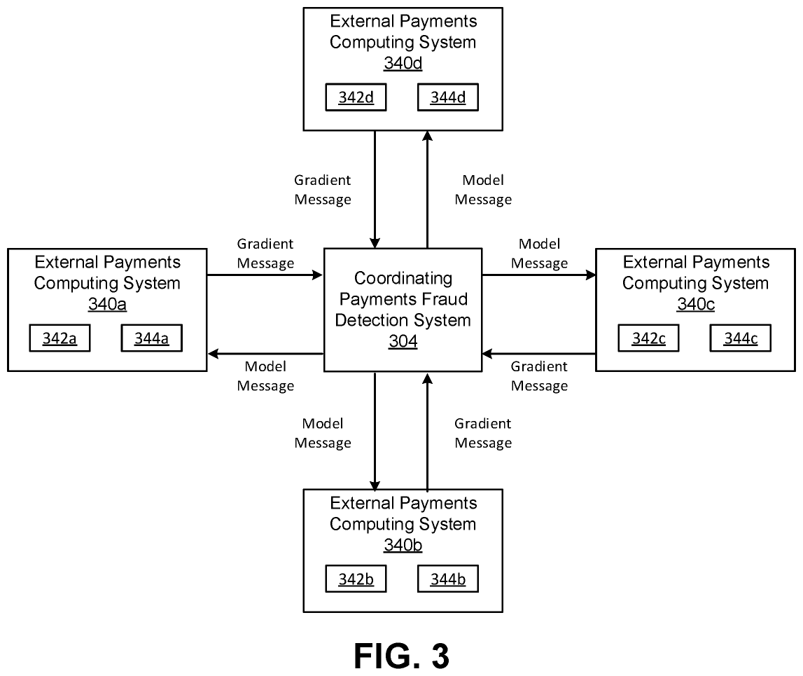

FIG. 3 shows an illustrative system for decentralized, privacy preserving, payments fraud detection in accordance with one or more aspects described herein. The illustrative system of FIG. 3 may include a coordinating payments fraud detection system 104 (e.g., the coordinating payments fraud detection system 304) that may be located at a central or regional location. The system may also include a plurality of payments computing systems that may be internal and/or external to an enterprise computing system associated with the coordinating payments fraud detection system. In some cases, the coordinating payments fraud detection system 304 may be communicatively coupled to one or more payments systems on a same enterprise network (e.g., an application computing system 108 of FIG. 1) and/or one or more external payments computing systems 140 (e.g., the external payments computing systems 340a-d, as shown in FIG. 3. Each decentralized privacy preserving fraud detection system 342a-d may be associated with a corresponding external payments computing system 340a-d and data stores 344a-d.

The coordinating payments fraud detection system 304 may train a fraud detection model for monitoring and detecting signs and/or indicators of fraud in a payments transaction. The model may be trained based on one or more payments processing protocols and/or standards, such as those discussed above (e.g., ISO 20022 and ISO 8583) and/or a proprietary protocol and may incorporate fields common to two or more standards or protocols, mappings of fields between two or more standards or protocols, or fields or parameters unique to individual standards or protocols. In some cases, the training data set may be sanitized, anonymized otherwise created data sets that do not include private or secure information (e.g., names, account numbers, identifiers, and the like). In an illustrative example, the external payments computing system 340a may utilize a first standard protocol, the external payments computing system 340b may utilize a second standard protocol, the external payments computing system 340c may utilize a first proprietary protocol, and the external payments computing system 340d may utilize a second proprietary protocol. The coordinating payments fraud detection system 304 may train a model based on a data set comprising fields on at least the first standard protocol, the second standard protocol, the first proprietary protocol, and/or the second proprietary protocol. The training data set may include verified identifying patterns associated with verified fraudulent transactions as found with one or more different protocols. Once trained, the model may be communicated, such as via a model message from the coordinating payments fraud detection system 304 to each decentralized privacy preserving fraud detection system 342a-d associated with the corresponding external payments computing system 340a-d. The model message to the decentralized privacy preserving fraud detection systems 342a-d may be coordinated or may be sent as a broadcast message to all decentralized privacy preserving fraud detection systems 342a-d.

A participating external payments computing system 340a may include computing devices across multiple regions and/or geographical locations, where the decentralized privacy preserving fraud detection system 342a may perform Nc epochs of gradient descent on its local dataset utilizing the trained model while monitoring the real-time payments transactions being performed by the payments computing system 340a. The decentralized privacy preserving fraud detection system 342a sends only the updated gradients and not its dataset to the coordinating payments fraud detection system 304. The updates may be sent asynchronously or synchronously depending on a configuration of the system. The coordinating payments fraud detection system 304 then aggregates the updated gradients sent from the clients and sends the aggregated gradients to the decentralized privacy preserving fraud detection systems 342a-d at the beginning of the next federated round.

In doing so, privacy of the data on each participating external payments computing system 340a and/or internal payments processing application computing system 108 is preserved because the local data sets do not leave the corresponding local network. Additionally, differential privacy data security is further enhanced by selective gradient clipping. The infrastructure costs remain low because each data center implementing the decentralized privacy preserving fraud detection systems 342a-d operate with minimal high-performance computing resources such as graphics processing units (GPUs). All decentralized privacy preserving fraud detection systems 342a-d are highly robust due to information diffusion occurring at the coordinating payments fraud detection system 304 during each federated round. A trained model utilizing these methods allows a fraud detection system to be compatible with all modes of payment initiation. Additionally, the fraud detection system identifies fraudulent transaction in real-time and communicates an alert to an affected customer, institutional security teams and/or external law enforcement computing systems.

An illustrative example, utilizing the systems and methods discussed above may include an organization such as a multinational financial organization may begin operations in a new country, such as Indonesia. As such, the localized data (e.g., identifier transactional data, transactional data, and the like) may be used when training a global fraud detection system. Here, the client fraud detection model (e.g., a deep learning model) may be deployed in a payments data warehouse computing system within Indonesia. The trained fraud detection model may include weights and biases (e.g., trainable parameters neural network parameters used to simplify machine learning data identification that may improve neural network data flow forward through the network in forward propagation) sent by the fraud detection server and are represented by the symbol W_{N}. The Indonesia local model then initializes its trainable parameters from W_{N}. For example, the current model with gradients W_{N} is trained on the features extracted from the Indonesia payments dataset. As the result of training the gradient of the model's parameters may change and may be represented as Wᵢₙ₊₁. The gradient of the model's parameters Wᵢₙ₊₁ is then communicated to the coordinating central server, such as via a P2P network or other secure network. The centralized server then aggregates the updated parameters received from Indonesia (Wᵢₙ₊₁) and other participating regions (e.g., the United States, Wᵤₛ₊₁, Europe, Wₑₚ₊1, and the like) using a specific algorithm (e.g., a summing algorithm, a weighted summing algorithm, and the like) and produces W_{N+1}. W_{N}, Wᵢₙ₊₁ are a set of n dimensional matrices and do not contain any transactional data. Once calculated the updated model is communicated to the remote computing systems for further processing. In some cases, an update to the local model is triggered by the central server based on receipt of an update. In some cases, the central server triggers an update to a plurality of local models based on a command sent with or after sending of the model update.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A computing platform comprising:
a processor; and
memory storing instructions that, when executed by the processor, cause the computing platform to:
train an artificial intelligence/machine learning (AI/ML) model on a training data set;
communicate, via a network and to a plurality of payments computing systems, the trained model;
receive, via the network, a gradient update to a local model on a first payments computing system of the plurality of payments computing systems;
re-train the model based on the gradient update; and
communicate, via the network and to the plurality of payments computing systems, the re-trained model to each of the plurality of payments computing systems.

2. The computing platform of claim 1, wherein the instructions cause the computing platform to aggregate gradient updates received from at least two payments computing systems of the payments computing systems.

3. The computing platform of claim 1, wherein the instructions cause the computing platform to retrain the model based on aggregated gradient updates received from at least two payments computing systems of the payments computing systems.

4. The computing platform of claim 1, wherein at least one payments system of the plurality of payments computing system communicates via an enterprise computing network local to the computing platform.

5. The computing platform of claim 1, wherein at least one payments system of the plurality of payments computing system communicates via an external computing network communicatively coupled to the network and wherein the network is local to the computing platform.

6. The computing platform of claim 1, wherein the first payments computing system operates using a first messaging protocol and a second computing payments system operates using a second messaging protocol.

7. The computing platform of claim 1, wherein the first payments computing system operates using a standard messaging protocol and a second payments computing system operates using a proprietary messaging protocol.

8. Non-transitory computer readable media storing instructions that, when executed by a processor, cause a fraud detection system to:
train an artificial intelligence/machine learning (AI/ML) model on a training data set;
communicate, via a network and to a plurality of payments computing systems, the trained model;
receive, via the network, a gradient update to a local model on a first payments computing system of the plurality of payments computing systems;
re-train the model based on the gradient update; and
communicate, via the network and to the plurality of payments computing systems, the re-trained model to each of the plurality of payments computing systems.

9. The non-transitory computer readable media of claim 8, wherein the instructions cause the fraud detection system to aggregate gradient updates received from at least two payments computing systems of the payments computing systems.

10. The non-transitory computer readable media of claim 8, wherein the instructions cause the fraud detection system to retrain the model based on aggregated gradient updates received from at least two payments computing systems of the payments computing systems.

11. The non-transitory computer readable media of claim 8, wherein at least one payments system of the plurality of payments computing system communicates via an enterprise computing network local to the fraud detection system.

12. The non-transitory computer readable media of claim 8, wherein at least one payments system of the plurality of payments computing system communicates via an external computing network communicatively coupled to the network and wherein the network is local to the fraud detection system.

13. The non-transitory computer readable media of claim 8, wherein the first payments computing system operates using a first messaging protocol and a second payments computing system operates using a second messaging protocol.

14. The non-transitory computer readable media of claim 8, wherein the first payments computing system operates using a standard messaging protocol and a second payments computing system operates using a proprietary messaging protocol.

15. A method comprising:
training, by a computing platform, an artificial intelligence/machine learning (AI/ML) model on a training data set;
communicating, via a network and to a plurality of payments computing systems, the trained model;
receiving, via the network, a gradient update to a local model on a first payments computing system of the plurality of payments computing systems;
re-training the model based on the gradient update; and
communicating, via the network and to the plurality of payments computing systems, the re-trained model to each of the plurality of payments computing systems.

16. The method of claim 15, further comprising aggregating gradient updates received from at least two payments computing systems of the payments computing systems.

17. The method of claim 15, further comprising retraining the model based on aggregated gradient updates received from at least two payments computing systems of the payments computing systems.

18. The method of claim 15, wherein at least one payments system of the plurality of payments computing system communicates via an enterprise computing network local to the computing platform.

19. The method of claim 15, wherein at least one payments system of the plurality of payments computing system communicates via an external computing network communicatively coupled to the network and wherein the network is local to the computing platform.

20. The method of claim 15, wherein the first payments computing system operates using a first messaging protocol and a second payments computing system operates using a second messaging protocol.
